(19) United States
(12) Patent Application Publication
(10) Pub. No.: US 2010/0328074 A1
(43) Pub. Date: Dec. 30, 2010

(54) HUMAN PRESENCE DETECTION TECHNIQUES

(76) Inventors: Erik J. Johnson, Portlan, OR (US); Dattatraya H. Kulkarni, Santa Clara, CA (US); Uttam K. Sengupta, Portland, OR (US)

Correspondence Address: KACVINSKY DAISAK PLLC, C/O CPA Global, P.O. BOX 52050, MINNEAPOLIS, MN, 55402, US

(21) Appl. No.: 12/495,469

(22) Filed: Jun. 30, 2009

(51) Int. Cl. G08B 23/00

(52) U.S. Cl. 340/573.1

(57) ABSTRACT

Human presence techniques are described. For instance, an apparatus may comprise one or more physical sensors operative to monitor one or more physical characteristics of an electronic device, and a security controller communicatively coupled to the one or more physical sensors. The security controller may be operative to control security for the electronic device, the security controller comprising a human presence module operative to receive a request to verify a presence of a human operator, determine whether the human operator is present at the electronic device based on sensor data received from the one or more physical sensors for the electronic device, the sensor data representing one or more physical characteristics of the electronic device, and generate a human presence response indicating whether the human operator is present or not present at the electronic device based on the sensor data. Other embodiments are described and claimed.

### BACKGROUND

Security techniques are used to control access to applications, services or devices. This is particularly important for online services, since automated computer programs such as a “botnet” can attempt to maliciously access online services or spoof legitimate users without any human intervention. A “botnet” is a large number of Internet-connected computers that have been compromised and run automated scripts and programs which are capable of sending out massive amounts of spam emails, voice-over-internet-protocol (VoIP) messages, authentication information, and many other types of Internet communications.

Some security techniques attempt to reduce such automated and malicious threats by verifying that an actual human being is attempting to access an application, service or device. For instance, one widely-used solution utilizes a CAPTCHA. A CAPTCHA is a type of challenge-response test used in computing to ensure that the response is not generated by a computer. The process usually involves a computer asking a user to complete a simple test which the computer is able to generate and grade, such as entering letters or digits shown in a distorted image. A correct solution is presumed to be from a human. Despite the sophistication provided by a CAPTCHA system, however, some CAPTCHA systems can still be broken by automated software. Further, CAPTCHA systems present a frustrating and inconvenient user experience. It is with respect to these and other considerations that the present improvements are needed.

### BRIEF DESCRIPTION OF THE DRAWINGS

FIG. 1 illustrates one embodiment of a first apparatus.

FIG. 2 illustrates one embodiment of an operating embodiment.

FIG. 3 illustrates one embodiment of a logic flow.

FIG. 4 illustrates one embodiment of a second apparatus.

FIG. 5 illustrates one embodiment of a system.

### DETAILED DESCRIPTION

Various embodiments are generally directed to techniques for detecting a presence of a human being utilizing an electronic device. Some embodiments are particularly directed to human presence detection techniques utilizing one or more physical sensors designed to monitor and capture sensor data regarding one or more physical characteristics of an electronic device. To verify presence for a human operator, an electronic device may be manipulated in a physical manner that changes one or more physical characteristics for the electronic device that is detectable by the physical sensors. For instance, the electronic device may be physically moved in a defined pattern or sequence, such as shaken, moved up-and-down, rotated, and so forth. The electronic device may also be physically touched by the human operator in a defined pattern or sequence, such as touching various parts of a housing or external component (e.g., a touch screen, human interface device, etc.) for the electronic device with a certain amount of force, pressure and direction over a given time period. The collected sensor data may then be used to confirm or verify the presence of a human operator of the electronic device. In this manner, security techniques may implement one or more of the human presence detection techniques for a device, system or network to verify that an actual human being is attempting to access an application, device, system or network, thereby reducing threats from automated computer programs.

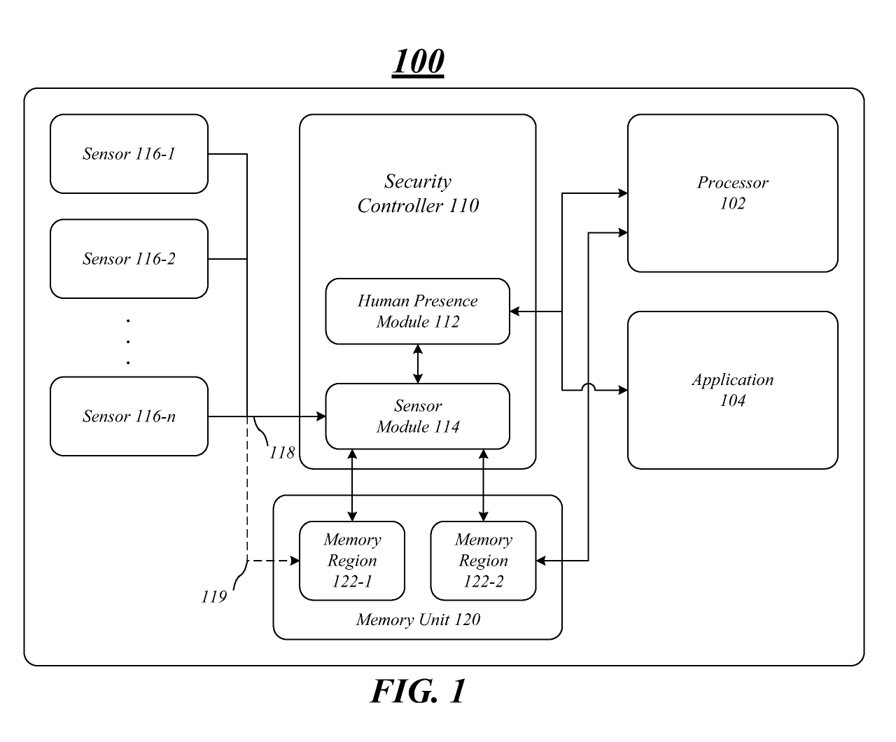

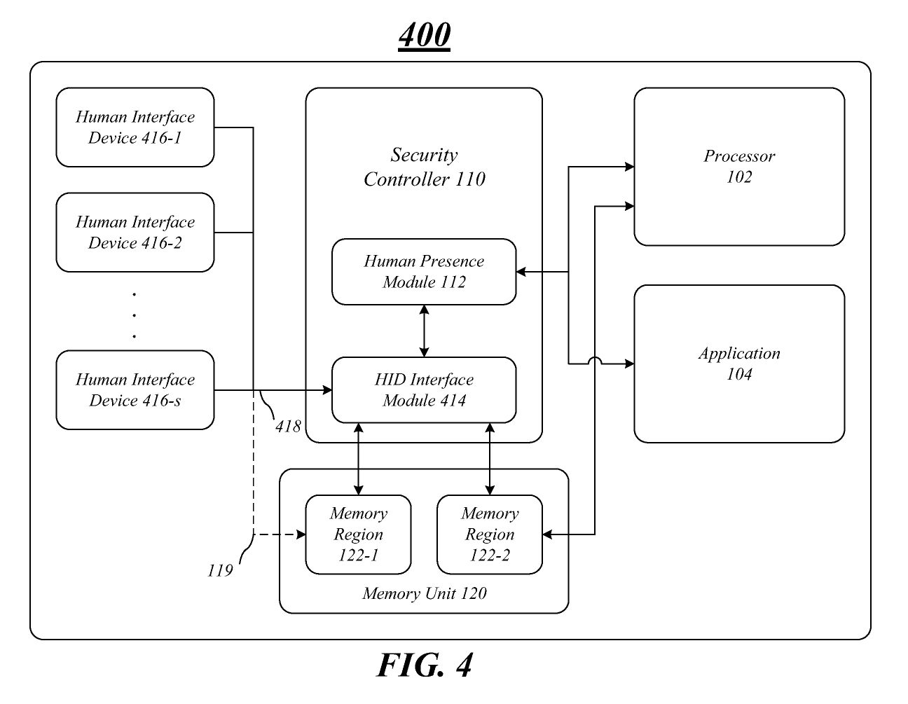

In one embodiment, for example, an apparatus such as an electronic device may include one or more physical sensors operative to monitor one or more physical characteristics of the electronic device, as described in more detail with reference to FIG. 1. Additionally or alternatively, the apparatus may include one or more human interface devices (e.g., a keyboard, mouse, touch screen, etc.) operative to receive multimodal inputs from a human being, as described in more detail with reference to FIG. 4.

A security controller may be communicatively coupled to the one or more physical sensors and/or human interface devices. The security controller may be generally operative to control security for the electronic device, and may implement any number of known security and encryption techniques. In addition, the security controller may include a human presence module. The human presence module may be arranged to receive a request to verify a presence of a human operator. The request may come from a local application (e.g., a secure document) or a remote application (e.g., a web server accessed via a web browser). The human presence module may determine whether the human operator is present at the electronic device by evaluating and analyzing sensor data received from the one or more physical sensors for the electronic device, or multimodal inputs from the one or more human interface devices. The sensor data may represent one or more physical characteristics of the electronic device. The human presence module may then generate a human presence response indicating whether the human operator is present or not present at the electronic device based on the sensor data and/or multimodal inputs. Other embodiments are described and claimed.

Embodiments may include one or more elements. An element may comprise any structure arranged to perform certain operations. Each element may be implemented as hardware, software, or any combination thereof, as desired for a given set of design parameters or performance constraints. Although embodiments may be described with particular elements in certain arrangements by way of example, embodiments may include other combinations of elements in alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

FIG. 1 illustrates an exemplary apparatus 100 that may be used for human presence detection. The human presence detection may be used for granting or denying access to an application, service, device, system or network.

As shown in FIG. 1, the apparatus 100 may include various elements. For instance, FIG. 1 shows that apparatus 100 may include a processor 102. The apparatus 100 may further include a security controller 110 communicatively coupled to various physical sensors 116-1-n. Also, the apparatus 100 may include one or more memory units 120-1-p separated into various memory regions 122-1-r. Further, the apparatus 100 may include an application 104.

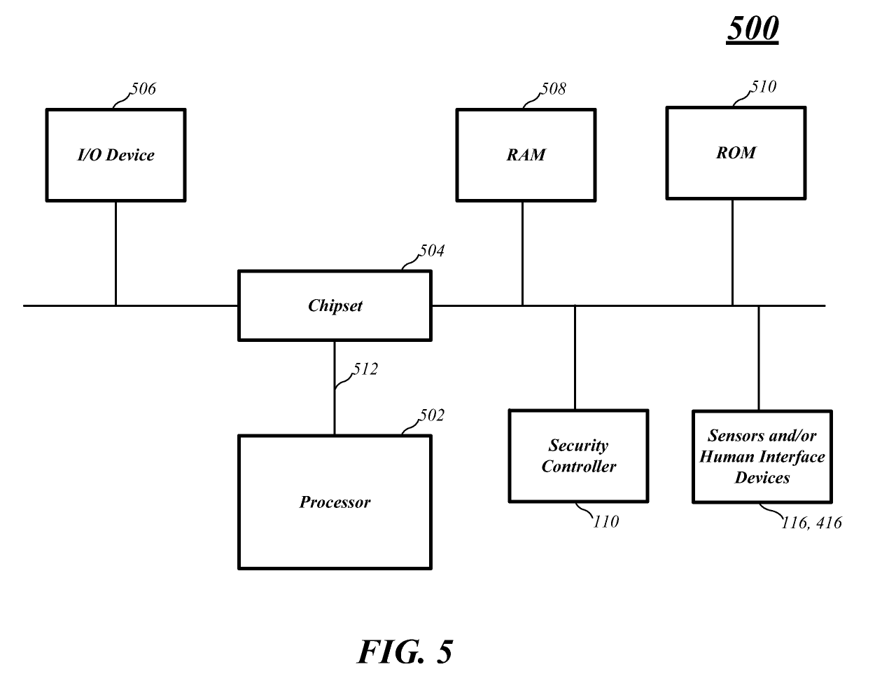

In certain embodiments, the elements of apparatus 100 may be implemented within any given electronic device. Examples of suitable electronic devices may include without limitation a mobile station, portable computing device with a self-contained power source (e.g., battery), a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communications device, computer, personal computer, server, workstation, network appliance, electronic gaming system, navigation system, map system, location system, and so forth. In some embodiments, an electronic device may comprise multiple components. In this case, the apparatus 100 may be implemented as part of any one of the multiple components (e.g., a remote control for a game console). In one embodiment, for example, the apparatus 100 may be implemented as part of a computing platform for a computing device, examples of which are described with reference to FIG. 5. In further embodiments, however, implementations may involve external software and/or external hardware. The embodiments are not limited in this context.

The apparatus 100 may include the processor 102. The processor 102 may have one or more processor cores. The processor may run various types of applications as represented by the application 104. Examples for the processor 102 are described with reference to FIG. 5.

The apparatus 100 may include the application 104. The application 104 may comprise any application program stored and executed by the processor 102. Furthermore, the application 104 may have embedded security features to access documents, features or services provided by the application 104. As such, the application 104 may serve as a client for security services provided by the security controller 110. The application 104 may comprise a local application residing on a computing device, or a remote application residing on a remote device (e.g., a web server). In one embodiment, for example, the application 104 may be implemented as a web browser to access a remote device, such as a web server.

The apparatus 100 may include one or more physical sensors 116-1-n arranged to monitor one or more physical characteristics of the computing device. The monitoring may occur on a continuous, periodic, aperiodic or on-demand basis. Examples of physical characteristics may include without limitation movement, orientation, rotational speed, torque, velocity, force, pressure, temperature, light sensitivity, weight, vibration, chemical composition, deformation, momentum, altitude, location, heat, energy, power, electrical conductivity, resistance, and so forth. Examples of physical sensors 116-1-n include without limitation an accelerometer, a decelerometer, a magnetometer (e.g., a compass), a gyroscope, a proximity sensor, ambient light sensor, a heat sensor, a tactile sensor, a chemical sensor, a temperature sensor, a touch screen, a barometer, audio sensor, and so forth. The physical sensors 116-1-n may comprise hardware sensors, software sensors, or a combination of both. Examples of software sensors may include application events, timers, interrupts, and so forth. Any known type of physical sensor may be implemented for the physical sensors 116-1-n, and the embodiments are not limited in this context.

The physical sensors 116-1-n may output sensor data 118 to the security controller 110. More particularly, the physical sensors 116-1-n may output sensor data 118 to the sensor module 114 of the security controller 110. The sensor data 118 may comprise measured values of a physical characteristic of an electronic device. The sensor data 118 may represent independent values or differential values (e.g., differences between a current measured value and a previously measured value). The embodiments are not limited in this context.

The apparatus 100 may include the security controller 110. The security controller 110 may be communicatively coupled to the one or more physical sensors 116-1-n. The security controller 110 may be generally operative to control security for a computing device, and may implement any number of known security and encryption techniques. In one embodiment, for example, the security controller 110 may provide various software and hardware features needed to enable a secure and robust computing platform. For example, the security controller 110 may provide various security components and capabilities such as secure boot, secure execution environments, secure storage, hardware cryptographic acceleration for various security algorithms and encryption schemes (e.g., Advanced Encryption Standard, Data Encryption Standard (DES), Triple DES, etc.), Public Key Infrastructure (PKI) engine supporting RSA and Elliptical Curve Cryptography (ECC), hashing engines for Secure Hash Function (SHA) algorithms (e.g., SHA-1, SHA-2, etc.), Federal Information Processing Standards (FIPS) compliant Random Number Generation (RNG), Digital Rights Management (DRM), secure debug through Joint Test Action Group (JTAG), memory access control through isolated memory regions (IMR), inline encrypt and decrypt engines for DRM playback, additional security timers and counters, and so forth. In some embodiments, the security controller 110 may comprise a hardware security controller, such as an Intel® Active Management Technology (AMT) device made by Intel Corporation, Santa Clara, Calif. In other embodiments, the security controller 110 may be a hardware security controller related to the Broadcom® DASH (Desktop and Mobile Architecture for System Hardware) web services-based management technology. In yet other embodiments, the security controller 110 may be implemented by other types of security management technology. The embodiments are not limited in this context.

The apparatus 100 may also include one or more memory units 120-1-p with multiple memory regions 122-1-r. The embodiment illustrated in FIG. 1 shows a single memory unit 120 having two memory regions 122-1, 122-2. The first memory region 122-1 may comprise an isolated memory region. The second memory region 122-2 may comprise a shared memory region. In general, the isolated memory region 122-1 is accessible by only the security controller 110 and the one or more sensors 116-1-n. The shared memory region 122-2 is accessible by the security controller 110 and external components, such as the processor 102 and/or the application 104. Although a single memory unit 120 with multiple memory regions 122-1, 122-2 is shown in FIG. 1, it may be appreciated that multiple memory units 120-1, 120-2 may be implemented for the apparatus 100, with each memory unit 120-1, 120-2 having a respective memory region 122-1, 122-2. The embodiments are not limited in this context.

In various embodiments, the security controller 110 may include the human presence module 112. The human presence module 112 may be generally arranged to detect and verify whether a human operator is present at a computing device utilizing apparatus 100. The human presence module 112 may be a security sub-system of the security controller 110. In various embodiments, the human presence module 112 may be implemented with various hardware and software structures suitable for a security sub-system, such as one or more embedded security processors, interrupt controller, instruction cache, data cache, memory, cryptographic acceleration engines, hardware based RNG, secure JTAG, and other elements.

In various embodiments, the security controller 110 may include a sensor module 114. The sensor module 114 may be generally arranged to manage one or more of the sensors 116-1-n. For instance, the sensor module 114 may configure or program the sensors 116-1-n with operational values, such as detection thresholds and triggers. The sensor module 114 may also receive sensor data 118 from the one or more physical sensors 116-1-n. The sensor data 118 may represent one or more physical characteristics of a computing device utilizing the apparatus 100 when the computing device is manipulated in accordance with a presence action sequence as described below. The sensor module 114 may pass the sensor data 118 directly to the human presence module 112 for analysis. Additionally or alternatively, the sensor module 114 may store the sensor data 118 in the isolated memory region 122-1.

It is worthy to note that although the sensor module 114 is shown in FIG. 1 as part of the security controller 110, it may be appreciated that the sensor module 114 may be implemented in another component of a computing system external to the security controller 110. For instance, the sensor module 114 may be integrated with an Input/Output (I/O) controller for a component external to the security controller 110, an external device, a dedicated controller for a sensor system, within a sensor 116-1-n, and so forth. In this case, the physical sensors 116-1-n may be arranged to bypass the security controller 110 entirely and store the sensor data 118 directly in the isolated memory region 122-1 as indicated by the dotted arrow 119. Such an implementation should ensure there is a secure connection between the physical sensors 116-1-n and the isolated memory region 122-1. The embodiments are not limited in this context.

In general operation, the human presence module 112 of the security controller 110 may confirm, verify or authenticate a human presence for a computing device as part of a security procedure or protocol. In one embodiment, the human presence module 112 may receive a request to verify a presence of a human operator of a computing device implementing the apparatus 100. The human presence module 112 may determine whether a human operator is present at the computing device by evaluating and analyzing sensor data 118 received from the one or more physical sensors 116-1-n for the computing device. The sensor data 118 may represent one or more physical characteristics of the computing device, as described in more detail below. The human presence module 112 may then generate a human presence response indicating whether the human operator is present or not present at the computing device based on the sensor data 118.

The human presence module 112 may generate a human presence response based on the sensor data 118 using a presence action sequence. Whenever the human presence module 112 receives a request to verify a human presence, the human presence module 112 may generate or retrieve a presence action sequence used to verify the human presence. For instance, various presence action sequences and associated values may be generated and stored in the isolated memory region 122-1 of the memory unit 120.

A presence action sequence may include one or more defined instructions for a human operator to physically manipulate a computing device or provide multimodal inputs to a computing device. For example, the defined instructions may include a specific form or pattern of motion (e.g., left-to-right, up-and-down, front-to-back, shaking back-and-forth, rotating in one or more directions, etc.) not typically found when a computing device is not used by a human operator. In this case, one of the physical sensors 116-1-n may be implemented as an accelerometer, gyroscope and/or barometer to detect the various movement patterns for a computing device. In another example, one of the physical sensors 116-1-n may be implemented as a light sensor. In this case, the defined instructions may include creating a specific light pattern by passing a human hand over the light sensor to cover or uncover the light sensor from ambient light. In yet another example, one of the physical sensors 116-1-n may be implemented as a heat sensor. In this case, the defined instructions may include touching a computing device at or around the heat sensor to detect typical human body temperatures. In still another example, one of the physical sensors 116-1-n may be implemented as a tactile sensor sensitive to touch. In this case, the defined instructions may include touching a computing device at certain points with a certain amount of pressure and possibly in a certain sequence. It may be appreciated that these are merely a limited number of examples for a presence action sequence suitable for a given set of physical sensors 116-1-n, and any number of defined instructions and corresponding physical sensors 116-1-n may be used as desired for a given implementation. Furthermore, different combinations of the physical sensors 116-1-n used for a given presence action sequence frequently increase a confidence level regarding the presence or absence of a human operator. The embodiments are not limited in this context.

Once an appropriate presence action sequence is generated or retrieved, the presence action sequence may be communicated to a human operator using various multimedia and multimodal outputs. For instance, an electronic display such as a Liquid Crystal Display (LCD) may be used to display a user interface message with the appropriate instructions for the presence action sequence, a set of images showing orientation of a computing device, icons showing movement arrows in sequence (e.g., up arrow, down arrow, left arrow, right arrow), animations of a user moving a computing device, videos of a user moving a computing device, and other multimedia display outputs. Other output devices may also be used to communicate the presence action sequence, such as flashing sequences on one or more light emitting diodes (LEDs), reproduced audio information (e.g., music, tones, synthesized voice) via one or more speakers, a vibration pattern using a vibrator element and other tactile or haptic devices, and so forth. The embodiments are not limited in this context.

Once a human operator physically manipulates a computing device in accordance with a presence action sequence, the sensor module 114 may receive the sensor data 118 from the one or more physical sensors 116-1-n for a computing device. The sensor data 118 represents changes or measurements in one or more physical characteristics of a computing device when a computing device is manipulated in accordance with a presence action sequence. The sensor module 114 stores the sensor data 118 in the isolated memory region 122-1, and sends a signal to the human presence module 112 that the sensor data 118 is ready for analysis.

The human presence module 112 receives the signal from the sensor module 114, and begins reading the sensor data 118 from the isolated memory region 122-1. The human presence module 112 compares the sensor data 118 representing measurements of physical characteristics by the physical sensors 116-1-n to a stored set of values or previous measurements associated with a given presence action sequence. The human presence module 112 sets a human presence response to a first value (e.g., logical one) to indicate the human operator is present at a computing device when changes in one or more physical characteristics of the computing device represented by the sensor data 118 matches a presence action sequence. The human presence module 112 sets a second value (e.g., logical zero) to indicate the human operator is not present at the computing device when changes in one or more physical characteristics of the computing device represented by the sensor data 118 do not match a presence action sequence.

It is worthy to note that human presence at a computing device refers to a human operator being proximate or near the computing device. The proximate distance may range from touching a computing device to within a given radius of the computing device, such as 10 yards. The given radius may vary according to a given implementation, but is generally intended to mean within sufficient distance that the human operator may operate the computing device, either directly or through a human interface device (e.g., a remote control). This allows a service requesting human presence verification to have a higher confidence level that a computing device initiating a service request is controlled by a human operator rather than an automated computer program. For example, a human being having a remote control for a computing device, such as a for a gaming system or multimedia conferencing system, is considered a human presence at the computing device. In some cases, the remote control itself may implement the apparatus 100 in which case it becomes an electronic device or computing device. The embodiments are not limited in this context.

Once the human presence module 112 generates or sets a human presence response to a proper state, the human presence module 112 may send the human presence response to the processor 102 or the application 104 using a suitable communications technique (e.g., radio, network interface, etc.) and communications medium (e.g., wired or wireless) for completing security operations (e.g., authentication, authorization, filtering, tracking, etc.). The security controller 110 may attach security credentials with the human presence response to strengthen verification. Additionally or alternatively, the human presence module 112 may store the human presence response and security credentials in one or both memory regions 122-1, 122-2.

In addition to generating a human presence response, the human presence module 112 may operate as a bridge to transport the sensor data 118 from the isolated memory region 122-1 to the shared memory region 122-2. For instance, when the human presence module 112 detects a human presence, the human presence module 112 may instruct the sensor module 114 to move the sensor data 118 from the isolated memory region 122-1 to the shared memory region 122-2. In this manner, the sensor data 118 may be accessed by the processor 102 and/or the application 104 for further analysis, validation, collect historical data, and so forth.

The human presence module 112 may also use the sensor data 118 to refine a presence action sequence. For instance, when a presence action sequence is performed by a human operator on a computing device, measured by the physical sensors 116-1-n, and validated as matching stored data associated with the presence action sequence, there may remain a differential between the actual measurements and stored values. These discrepancies may result from unique physical characteristics associated with a given computing device, a human operator, or both. As such, positive validations may be used as feedback to refine or replace the stored values to provide a higher confidence level when future matching operations are performed. In this manner, a computing device and/or human operator may train the human presence module 112 to fit unique characteristics of the computing device and/or human operator, thereby resulting in improved performance and accuracy in human presence detection over time.

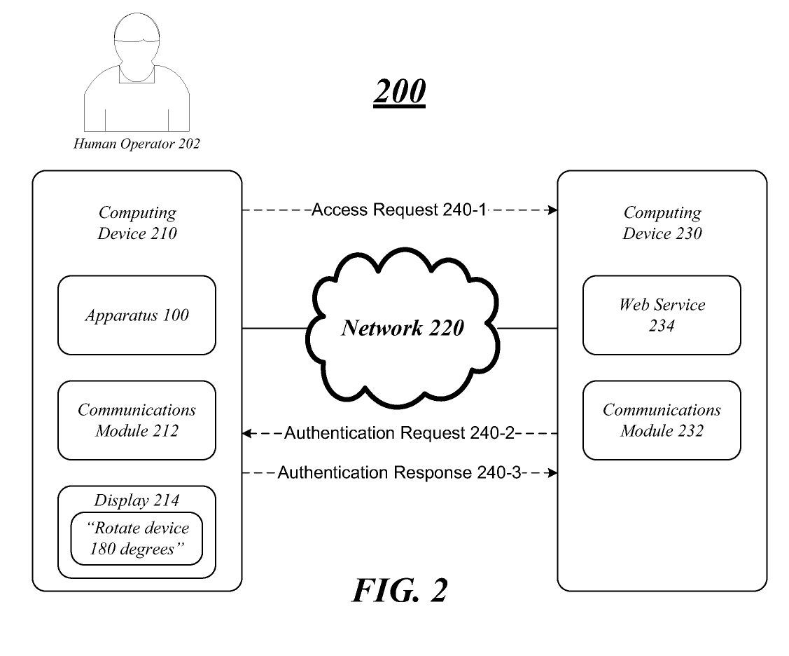

FIG. 2 illustrates an operating environment 200 for the apparatus 100. As shown in FIG. 2, a computing device 210 may include the apparatus 100 and a communications module 212. A computing device 230 may include a communications module 232 and a remote application providing a web service 234. The computing devices 210, 230 may communicate via the respective communications modules 212, 232 over the network 220. The communications modules 212, 232 may comprise various wired or wireless communications, such as radios, transmitters, receivers, transceivers, interfaces, network interfaces, packet network interfaces, and so forth. The network 220 may comprise a wired or wireless network, and may implement various wired or wireless protocols appropriate for a given type of network.

In general operation, the apparatus 100 may implement various human presence detection techniques within a security framework or architecture provided by the security controller 110, the application 104, a computing device 210, the network 220, or a remote device such as computing device 230. For instance, assume the apparatus 100 is implemented as part of the computing device 210. The computing device 210 may comprise, for example, a mobile platform such as a laptop or handheld computer. Further assume the computing device 210 is attempting to access a web service 234 provided by the computing device 230 through a web browser via the application 104 and the network 220. The computing device 210 may send an access request 240-1 from the application 104 to the web service 234 via the network 220 and communications modules 212, 232. The web service 234 may request confirmation that a human being is behind the access request 240-1 and not some automated software program. As such, the human presence module 112 may receive an authentication request 240-2 from the web service 234 asking the computing device 210 to verify a presence of a human operator 202 of the computing device 210. It is worthy to note that in this example, the authentication request 240-2 is merely looking to verify that the human operator 202 is present at the computing device 210 that initiated the access request 240-1, and not necessarily the identity of the human operator 202. Identity information for the human operator 202 may be requested from the human operator 202 using conventional techniques (e.g., a password, personal identification number, security certificate, digital signature, cryptographic key, etc.).

The human presence module 112 may determine whether the human operator 202 is present at the computing device 210 by evaluating and analyzing sensor data 118 received from the one or more physical sensors 116-1-n for the computing device. The sensor data 118 may represent various changes in one or more physical characteristics of the computing device 210 made in accordance with a presence action sequence as previously described above with reference to FIG. 1. For instance, assume the presence action sequence is to rotate the computing device 210 approximately 180 degrees from its current position. The human presence module 112 may generate a user interface message such as “Rotate device 180 degrees” and send the user interface message to a display controller for display by an LCD 214. The human operator 202 may then physically rotate the computing device 210 from its current position approximately 180 degrees, which is measured by one of the physical sensors 116-1 implemented as a gyroscope. As the human operator 202 rotates the computing device 210, the physical sensor 116-1 may send measured values to the sensor module 114 in the form of sensor data 118. Once rotation operations have been completed, the physical sensor 116-1 may send repeating sensor data 118 of the same values for some defined time period, at which the sensor module 114 may implicitly determine that the presence action sequence may be completed. Additionally or alternatively, the human operator 202 may send explicit confirmation that the presence action sequence has been completed via a human input device (e.g., a keyboard, mouse, touch screen, microphone, and so forth). The sensor module 114 may then store the sensor data 118 in the isolated memory region 122-1, and send a ready signal to the human presence module 112 to begin its analysis.

The human presence module 112 may then read the sensor data 118 stored in the isolated memory region 122-1, analyze the sensor data 118 to determine whether the presence action sequence was performed properly, generate a human presence response indicating whether the human operator 202 is present or not present at the computing device 210 based on the sensor data 118, and send the human presence response as part of an authentication response 240-3 to the web service 234 of the computing device 230 via the web browser of application 104 and the network 220. Optionally, security credentials for the security controller 110 and/or identity information for the human operator 202 may be sent with the authentication response 240-3 as desired for a given implementation. The web service 234 may determine whether to grant access to the web service 234 based on the authentication response 240-3 and the human presence response, security credentials and/or identity information embedded therein.

When sending a human presence response over the network 220, the human presence module 112 and/or the security controller 110 may send the human presence response over the network 220 using any number of known cryptographic algorithms or techniques. This prevents unauthorized access as well as “marks” the human presence response as trustworthy.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

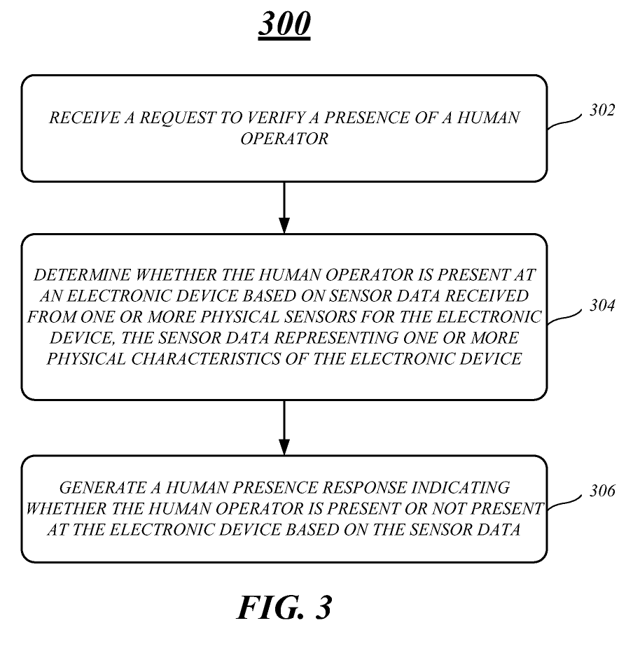

FIG. 3 illustrates one embodiment of a logic flow 300. The logic flow 300 may be representative of some or all of the operations executed by one or more embodiments described herein.

In the illustrated embodiment shown in FIG. 3, the logic flow 300 may receive a request to verify a presence of a human operator at block 302. For example, the human presence module 112 of the security controller 110 of the computing device 210 may receive a request to verify a presence of a human operator 202. In some cases, the presence of the human operator 202 may need to be completed within a certain defined time period. For example, when the access request 240-1 is transmitted and the authentication request 240-2 is received, the authentication response 240-3 with the human presence response may need to be received within a certain defined time period, with a shorter defined time period generally providing a higher confidence level that the human operator 202 is the same human operator initiating the access request 240-1 as being verified in the authentication response 240-3. As such, a timer (not shown) may be used to time stamp any of the requests 240-1, 240-2 or 240-3, the sensor data 118, and/or the human presence response generated by the human presence module 112.

The logic flow 300 may determine whether the human operator is present at a computing device based on sensor data received from one or more physical sensors for the computing device, the sensor data representing changes in one or more physical characteristics of the computing device at block 304. For example, the human presence module 112 may determine whether the human operator 202 is present at the computing device 210 based on sensor data 118 received from one or more physical sensors 116-1-n for the computing device 210. The sensor data 118 may represent changes in one or more physical characteristics of the computing device 210.

The logic flow 300 may generate a human presence response indicating whether the human operator is present or not present at the computing device based on the sensor data at block 306. For example, the human presence module 112 may generate a human presence response indicating whether the human operator 202 is present or not present at the computing device 210 based on the sensor data 118. For instance, the human presence module 112 may compare measured values from the physical sensors 116-1-n representing changes in one or more physical characteristics of the computing device 210 caused by the human operator in according with a presence action sequence with stored values associated with the presence action sequence. A positive match indicates a human presence by the human operator 202, while a negative match indicates no human presence by the human operator 202. In the latter case, the computing device 230 may assume an automated computer program is attempting to access the web service 234, and deny access to the web service 234 by the computing device 210.

FIG. 4 illustrates one embodiment of an apparatus 400. The apparatus 400 is similar in structure and operation as the apparatus 100. However, the apparatus 400 replaces the physical sensors 116-1-n with one or more human interface devices 416-1-s, and the corresponding sensor module 114 with a HID interface module 414. The human interface devices may comprise any input device suitable for a computing device. Examples of human interface devices 416-1-s may include without limitation a keyboard, mouse, touch screen, track pad, track ball, isopoint, a voice recognition system, microphone, camera, video camera, and/or the like. The embodiments are not limited in this context.

In operation, the apparatus 400 utilizes a presence action sequence to verify the presence or absence of the human operator 202 using verification operations similar to those described with reference to FIGS. 1-3. Rather than physically manipulating the computing device 210, however, a presence action sequence may instruct the human operator 202 to enter various multimodal inputs in a particular sequence. For instance, assume a presence action sequence include depressing several keys on a keypad, selecting a soft key displayed on a touch screen display, and audibly stating a name into a microphone for the computing device 210. Another example of a presence action sequence may include making hand signals (e.g., sign language) in front of a camera for the computing device 210. The HID interface module 414 may take the multimodal inputs 418 and store them in the isolated memory region 122-1, where the human presence module 112 may analyze and generate an appropriate human presence response based on the multimodal inputs 418.

Additionally or alternatively, the apparatus 100 and/or the apparatus 400 may be modified to include a combination of physical sensors 116-1-n and human interface devices 416-1-s. In this case, a presence action sequence may include a combination series of physical actions and multimodal inputs to further increase confidence that the human operator 202 is present at the computing device 210. For instance, a presence action sequence may have the human operator 202 shake the computing device 210 and blow air on a touch screen display (e.g., touch screen LCD 214). The modules 114, 414 may store the data 118, 418 in the isolated memory region 122-1 for analysis by the human presence module 112.

The apparatus 100 and the apparatus 400 may have many use scenarios, particularly for accessing online services. Internet service providers require (or desire) to know that a human is present during a service transaction. For example, assume the web service 234 is an online ticket purchasing service. The web service 234 would want to know that a human is purchasing tickets to ensure that a scalping “bot” is not buying all of the tickets only to sell them later on the black market. In another example, assume the web service 234 is an online brokerage service. The web service 234 would want to know that a human has requested a trade to prevent automated “pump-and-dump” viruses. In yet another example, assume the web service 234 is a “want-ads” service or a web log (“blog”). The web service 234 would want to know that a human is posting an advertisement or blog entry. In still another example, assume the web service 234 is an email service. The web service 234 would want to know that a human is signing up for a new account to ensure its service is not being used as a vehicle for “SPAM.” These are merely a few use scenarios, and it may be appreciated that many other use scenarios exist that may take advantage of the improved human presence detection techniques as described herein.

FIG. 5 is a diagram of a computing platform for a computing device 500. The computing device 500 may be representative of, for example, the computing devices 210, 230. As such, the computing device 500 may include various elements of the apparatus 100 and/or the operating environment 200. For instance, FIG. 5 shows that computing device 500 may include a processor 502, a chipset 504, an input/output (I/O) device 506, a random access memory (RAM) (such as dynamic RAM (DRAM)) 508, and a read only memory (ROM) 510, the security controller 110, and the sensors 122-1-m. The computing device 500 may also include various platform components typically found in a computing or communications device. These elements may be implemented in hardware, software, firmware, or any combination thereof. The embodiments, however, are not limited to these elements.

As shown in FIG. 5, I/O device 506, RAM 508, and ROM 510 are coupled to processor 502 by way of chipset 504. Chipset 504 may be coupled to processor 502 by a bus 512. Accordingly, bus 512 may include multiple lines.

Processor 502 may be a central processing unit comprising one or more processor cores. The processor 502 may include any type of processing unit, such as, for example, a central processing unit (CPU), multi-processing unit, a reduced instruction set computer (RISC), a processor that have a pipeline, a complex instruction set computer (CISC), digital signal processor (DSP), and so forth.

Although not shown, the computing device 500 may include various interface circuits, such as an Ethernet interface and/or a Universal Serial Bus (USB) interface, and/or the like. In some exemplary embodiments, the I/O device 506 may comprise one or more input devices connected to interface circuits for entering data and commands into the computing device 500. For example, the input devices may include a keyboard, mouse, touch screen, track pad, track ball, isopoint, a voice recognition system, and/or the like. Similarly, the I/O device 506 may comprise one or more output devices connected to the interface circuits for outputting information to an operator. For example, the output devices may include one or more displays, printers, speakers, LEDs, vibrators and/or other output devices, if desired. For example, one of the output devices may be a display. The display may be a cathode ray tube (CRTs), liquid crystal displays (LCDs), or any other type of electronic display.

The computing device 500 may also have a wired or wireless network interface to exchange data with other devices via a connection to a network. The network connection may be any type of network connection, such as an Ethernet connection, digital subscriber line (DSL), telephone line, coaxial cable, etc. The network (220) may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a storage medium, a computer-readable medium or an article of manufacture which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It should be understood that embodiments may be used in a variety of applications. Although the embodiments are not limited in this respect, certain embodiments may be used in conjunction with many computing devices, such as a personal computer, a desktop computer, a mobile computer, a laptop computer, a notebook computer, a tablet computer, a server computer, a network, a Personal Digital Assistant (PDA) device, a wireless communication station, a wireless communication device, a cellular telephone, a mobile telephone, a wireless telephone, a Personal Communication Systems (PCS) device, a PDA device which incorporates a wireless communication device, a smart phone, or the like. Embodiments may be used in various other apparatuses, devices, systems and/or networks.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving a request to verify a presence of a human operator;
determining whether the human operator is present at an electronic device based on sensor data received from one or more physical sensors for the electronic device, the sensor data representing one or more physical characteristics of the electronic device; and
generating a human presence response indicating whether the human operator is present or not present at the electronic device based on the sensor data.

2. The computer-implemented method of claim 1, comprising generating a presence action sequence having one or more defined instructions for the human operator to physically manipulate the electronic device.

3. The computer-implemented method of claim 1, comprising receiving the sensor data from the one or more physical sensors for the electronic device, the sensor data representing changes in one or more physical characteristics of the electronic device when the electronic device is manipulated in accordance with a presence action sequence.

4. The computer-implemented method of claim 1, comprising reading the sensor data from an isolated memory region.

5. The computer-implemented method of claim 1, comprising setting the human presence response to a first value to indicate the human operator is present at the electronic device when changes in one or more physical characteristics of the electronic device represented by the sensor data matches a presence action sequence.

6. The computer-implemented method of claim 1, comprising generating a human presence response to a second value to indicate the human operator is not present at the electronic device when changes in one or more physical characteristics of the electronic device represented by the sensor data do not match a presence action sequence.

7. The computer-implemented method of claim 1, comprising receiving the request from a local application.

8. The computer-implemented method of claim 1, comprising receiving the request from a remote application over a wired or wireless communications medium.

9. The computer-implemented method of claim 1, comprising sending the human presence response to a remote application over a wired or wireless communications medium using a cryptographic algorithm.

10. An apparatus, comprising:
one or more physical sensors operative to monitor one or more physical characteristics of an electronic device; and
a security controller communicatively coupled to the one or more physical sensors, the security controller operative to control security for the electronic device, the security controller comprising a human presence module operative to receive a request to verify a presence of a human operator, determine whether the human operator is present at the electronic device based on sensor data received from the one or more physical sensors for the electronic device, the sensor data representing changes in one or more physical characteristics of the electronic device, and generate a human presence response indicating whether the human operator is present or not present at the electronic device based on the sensor data.

11. The apparatus of claim 10, comprising one or more memory units with an isolated memory region and a shared memory region, the isolated memory region accessible by only the security controller and the one or more sensors.

12. The apparatus of claim 10, the one or more physical sensors comprising an accelerometer, a decelerometer, a magnetometer, a gyroscope, a proximity sensor, ambient light sensor, a heat sensor, a tactile sensor, or a touch screen.

13. The apparatus of claim 10, comprising a sensor module operative to receive the sensor data from the one or more physical sensors for the electronic device, the sensor data representing changes in one or more physical characteristics of the electronic device when the electronic device is manipulated in accordance with a presence action sequence, and store the sensor data in an isolated memory region.

14. The apparatus of claim 10, the human presence module operative to generate a presence action sequence having one or more defined instructions for the human operator to physically manipulate the electronic device.

15. The apparatus of claim 10, the human presence module operative to read the sensor data from an isolated memory region, set the human presence response to a first value to indicate the human operator is present at the electronic device when changes in one or more physical characteristics of the electronic device represented by the sensor data matches a presence action sequence, and a second value to indicate the human operator is not present at the electronic device when changes in one or more physical characteristics of the electronic device represented by the sensor data do not match a presence action sequence.

16. The apparatus of claim 10, the human presence module operative to instruct a sensor module to move the sensor data from an isolated memory region to a shared memory region for a processor.

17. The apparatus of claim 10, comprising a communications module communicatively coupled to the security controller, the human presence module operative to receive the request from a remote application using the communications module, and send the human presence response to the remote the remote application using the communications module.

18. The apparatus of claim 10, comprising a processor having multiple processor cores and a liquid crystal display.

19. An article comprising a storage medium containing instructions that when executed enable a system to:
receive a request to verify a presence of a human operator;
determine whether the human operator is present at an electronic device based on sensor data received from one or more physical sensors for the electronic device, the sensor data representing changes in one or more physical characteristics of the electronic device;
generate a human presence response indicating whether the human operator is present or not present at the electronic device based on the sensor data; and
send the human presence response to a processor or application.

20. The article of claim 19, further comprising instructions that when executed enable the system to read the sensor data from an isolated memory region, set the human presence response to a first value to indicate the human operator is present at the electronic device when changes in one or more physical characteristics of the electronic device represented by the sensor data matches a presence action sequence, and set the human presence response to a second value to indicate the human operator is not present at the electronic device when changes in one or more physical characteristics of the electronic device represented by the sensor data do not match a presence action sequence.
